(19) United States
(12) Patent Application Publication
(10) Pub. No.: US 2010/0149114 A1
(43) Pub. Date: Jun. 17, 2010

(54) SIMULATING A MULTI-TOUCH SCREEN ON A SINGLE-TOUCH SCREEN

(75) Inventor: Xiao-Xian Li, Shanghai (CN)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/335,746

(22) Filed: Dec. 16, 2008

(51) Int. Cl. G06F 3/041

(52) U.S. Cl. 345/173

(57) ABSTRACT

Disclosed is a single-touch screen interface that supports two operational states. First is a traditional single-touch state. Second is a “simulated multi-touch state” which allows the user to interact with the single-touch screen in much the same way as he would interact with a multi-touch screen. The user, while in the single-touch state, selects the simulated multi-touch state by performing a special “triggering” action, such as clicking or double clicking on the display screen. The location of the triggering input defines a “reference point” for the simulated multi-touch state. While in the simulated multi-touch state, this reference point is remembered, and it is combined with further touch input to control a simulated multi-touch operation. When the simulated multi-touch operation is complete, the interface returns to the single-touch state. In some embodiments, the user can also leave the simulated multi-touch state without completing a simulated multi-touch operation.

### FIELD OF THE INVENTION

The present invention is related generally to user interfaces for computing devices and, more particularly, to touch-screen interfaces.

### BACKGROUND OF THE INVENTION

Touch screens are becoming very common, especially on small, portable devices such as cellular telephones and personal digital assistants. These small devices often do not have enough room for a full-size keyboard. Touch screens allow them to simultaneously use the “real estate” of their display screens both for display and for input.

The vast majority of touch screens are “single-touch,” that is, their hardware and software can only resolve one touch point at a time. If a user simultaneously touches a single-touch screen at more than one place, then the screen may either interpolate the multiple touches into one irrelevant touch point or, upon recognizing that multiple touches are present but not being able to resolve them, may not register a touch at all. A user of a single-touch screen quickly learns not to accidentally let his palm or multiple fingers rest against the screen. Despite this limitation, single-touch screens are very useful, and users are beginning to expect them on new devices.

“Multi-touch” screens have been developed that can resolve more than one simultaneous touch. Users find these screens very useful, because multiple touches allow users to simultaneously control multiple aspects of a display interface. Making an analogy to music, using a single-touch screen is like playing a single-finger rendition of a song on a piano: Only the melody can be rendered. With multi-touch, a ten-finger piano player can add harmony and accompanying themes to the melody line.

For the time being, however, multi-touch screens will remain somewhat rare due to their substantially greater cost and complexity when compared to single-touch screens.

### BRIEF SUMMARY

The above considerations, and others, are addressed by the present invention, which can be understood by referring to the specification, drawings, and claims. According to aspects of the present invention, many of the benefits of an expensive multi-touch screen are provided by an inexpensive single-touch screen supported by enhanced programming. The enhanced programming supports two operational states for the single-touch screen interface. First is the single-touch state in which the screen operates to support a traditional single-touch interface. Second is a “simulated multi-touch state” in which the programming allows the user to interact with the single-touch screen in much the same way as he would interact with a multi-touch screen.

In some embodiments, the user, while in the single-touch state, selects the simulated multi-touch state by performing a special “triggering” action, such as clicking or double clicking on the display screen. The location of the triggering input defines a “reference point” for the simulated multi-touch state. While in the simulated multi-touch state, this reference point is remembered, and it is combined with further touch input (e.g., clicks or drags) to control a simulated multi-touch operation. When the simulated multi-touch operation is complete, the interface returns to the single-touch state. In some embodiments, the user can also leave the simulated multi-touch state by either allowing a timer to expire without completing a simulated multi-touch operation or by clicking a particular location on the display screen (e.g., on an actionable icon).

As an example, in one embodiment, the reference point is taken as the center of a zoom operation, and the user's further input while in the simulated multi-touch state controls the level of the zoom operation.

Operations other than zoom are contemplated, including, for example, a rotation operation. Multiple operations can be performed simultaneously. In some embodiments, the user can redefine the reference point while in the simulated multi-touch state.

Some embodiments tie the simulated multi-touch operation to the application software that the user is running. For example, a geographical navigation application supports particular zoom, transfer, and rotation operations with either single-touch or simulated multi-touch actions. Other applications may support other operations.

It is expected that most early implementations will be made in the software drivers for the single-touch display screen, while some implementations will be made in the user-application software. Some future implementations may support the simulated multi-touch state directly in the firmware drivers for the display screen.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIGS. 1a and 1b are simplified schematics of a personal communication device that supports a simulated multi-touch screen according to aspects of the present invention;

FIG. 2a is an initial view of a map, FIG. 2b is a desired view of the map of FIG. 2a, and FIG. 2c is an action diagram showing how a user moves from the view of FIG. 2a to the view of FIG. 2b using a widget-based, single-touch user interface;

FIG. 3 is an action diagram showing how a user moves from the view of FIG. 2a to the view of FIG. 2b using a multi-touch user interface;

FIG. 4 is a flowchart of an exemplary method for simulating a multi-touch operation on a single-touch screen;

FIG. 5 is an action diagram showing how a user moves from the view of FIG. 2a to the view of FIG. 2b using a simulated multi-touch user interface; and

FIG. 6 is a table comparing the actions the user performs in the methods of FIGS. 2c, 3, and 5.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

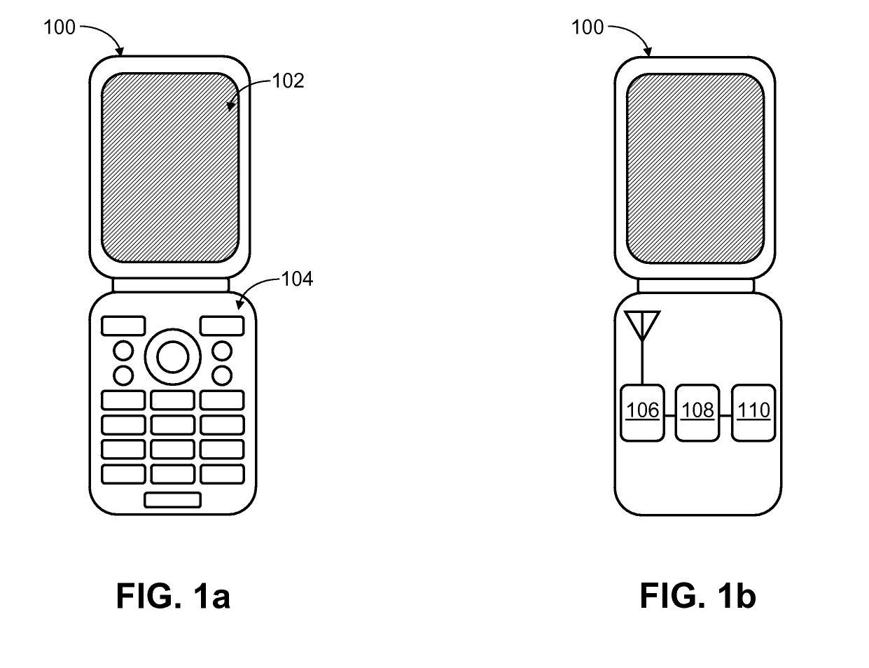

FIGS. 1a and 1b show a personal portable device 100 (e.g., a cellular telephone, personal digital assistant, or personal computer) that incorporates an embodiment of the present invention in order to provide many of the advantages of a multi-touch display screen with a less expensive single-touch screen. FIGS. 1a and 1b show the device 100 in an open configuration, presenting its main display screen 102 to a user. In the present example, the main display screen 102 is a single-touch screen. Typically, the main display 102 is used for most high-fidelity interactions with the user. For example, the main display 102 is used to show video or still images, is part of a user interface for changing configuration settings, and is used for viewing call logs and contact lists. To support these interactions, the main display 102 is of high resolution and is as large as can be comfortably accommodated in the device 100.

The user interface of the personal portable device 100 includes, in addition to the single-touch screen 102, a keypad 104 or other user-input devices.

A typical personal portable device 100 has a second and possibly a third display screen for presenting status messages. These screens are generally smaller than the main display screen 102, and they are almost never touch screens. They can be safely ignored for the remainder of the present discussion.

FIG. 1b illustrates some of the more important internal components of the personal portable device 100. The device 100 includes a communications transceiver 106 (optional but almost ubiquitous), a processor 108, and a memory 110. In many embodiments, touches detected by a hardware driver for the single-touch screen 102 are interpreted by the processor 108. Applying the methods of the present invention, the processor 108 then alters the information displayed on the single-touch screen 102.

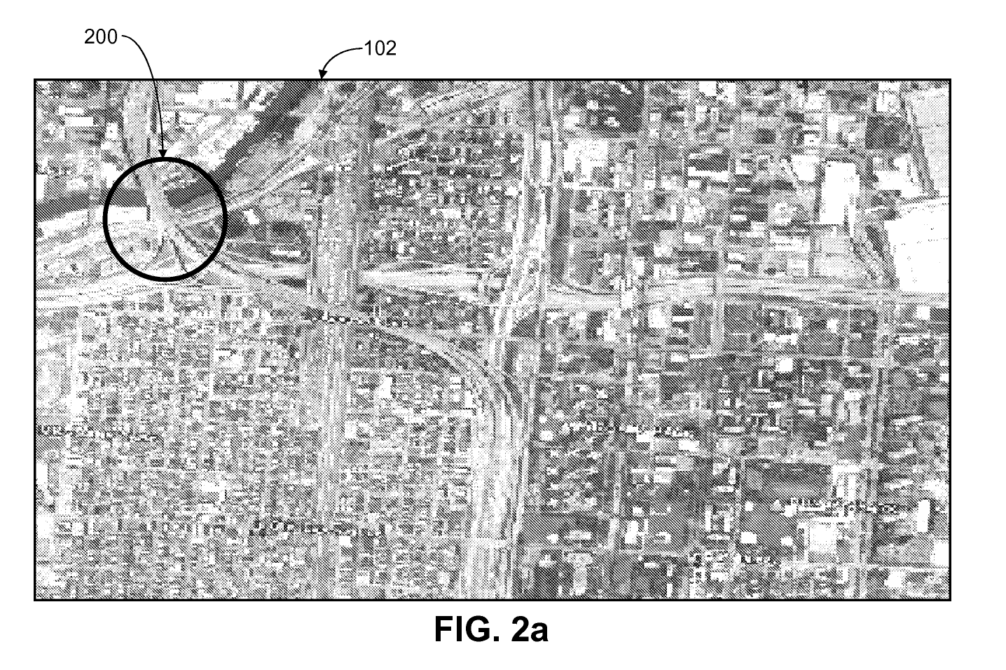

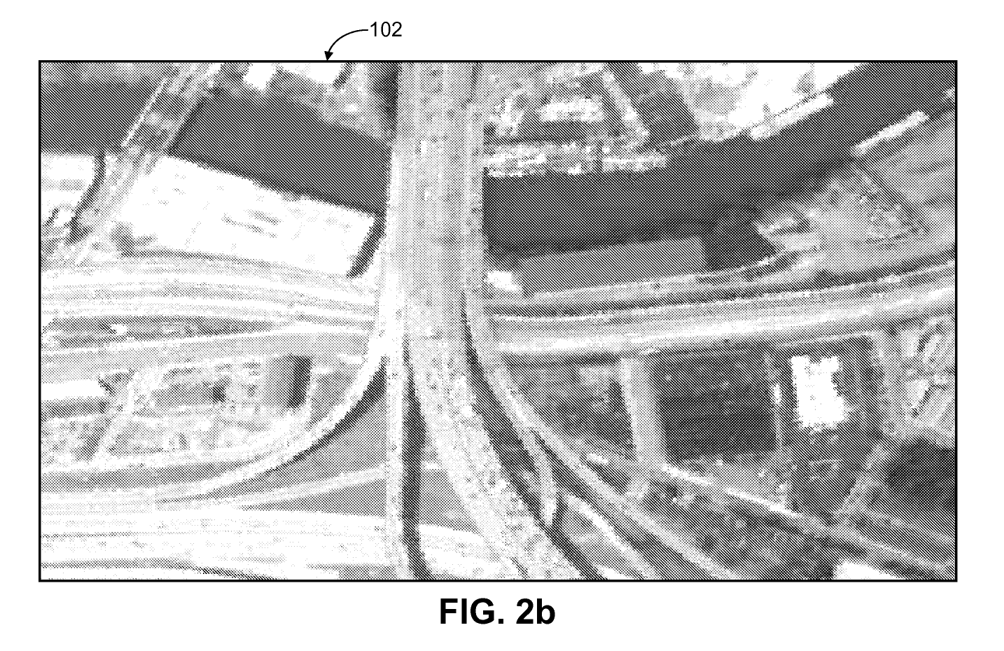

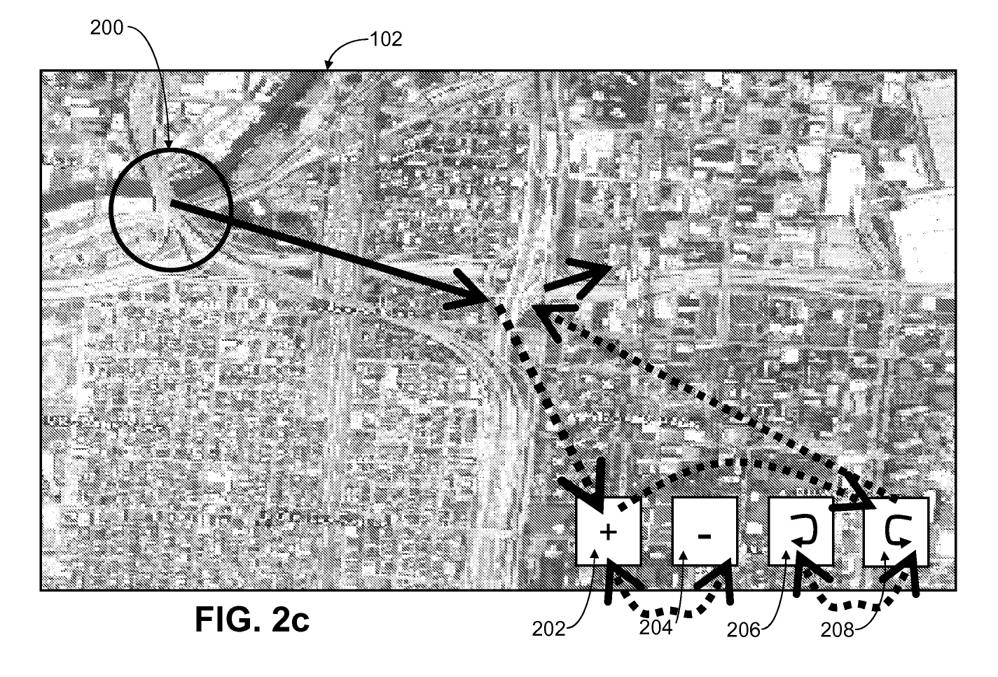

Before describing particular embodiments of the present invention, we consider how a user can navigate within a map application using various user interfaces. FIG. 2a shows an initial view of a map displayed on the screen 102 of the personal portable device 100. The user is interested in the portion of the map indicated by the circled area 200. FIG. 2b shows the map view that the user wants. Compared with the initial view in FIG. 2a, the desired view in FIG. 2b has a different center, has been zoomed in, and has been rotated slightly.

FIG. 2c illustrates a traditional, single-touch interface for the map application. To support navigation, the interface of FIG. 2c includes four actionable icons (or “widgets”). Touching widget 202 increases the zoom of the map display, while widget 204 reduces the zoom. Widgets 206 and 208 rotate the map clockwise and counterclockwise, respectively.

To use the interface of FIG. 2c to navigate from the initial view of FIG. 2a to the desired view of FIG. 2b, the user begins by touching the desired center point of the map and then “drags” that point to the map center. This is illustrated in FIG. 2c by the solid arrow from the center of the area 200 to the center of the display 102.

Next, the user raises his finger (or stylus or whatever pointing device he is using to interact with the single-touch screen 102), moves to the widget area, and clicks on the zoom widget 202. This is illustrated by a dotted arrow. The user may need to zoom in and out using widgets 202 and 204 until the correct zoom level is achieved. This is illustrated by the dotted arrow joining these two zoom widgets 202 and 204.

With the zoom set, the user moves his finger through the air (dotted arrow) to the pair of rotation widgets 206 and 208. Again, the user may have to click these widgets multiple times to achieve the correct rotation (dotted arrow joining the rotation widgets 206 and 208).

Finally, the user may need to move his finger in the air (dotted arrow) to the middle of the display screen 102 and readjust the map center by dragging (short solid arrow).

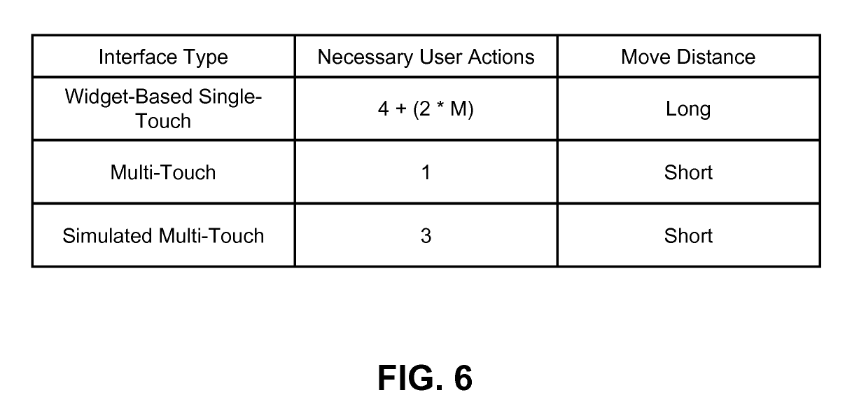

FIG. 6 is a table that compares the actions needed in various user interfaces to move from the initial view of FIG. 2a to the desired view of FIG. 2b. For the traditional, widget-based, single-touch interface of FIG. 2c, the navigation can take 4+(2*M) actions, including dragging to re-center the view, moving through the air to select the widgets, moving back and forth among each pair of widgets to set the correct zoom level and rotation amount, and moving back to the center of the display 102 to adjust the centering.

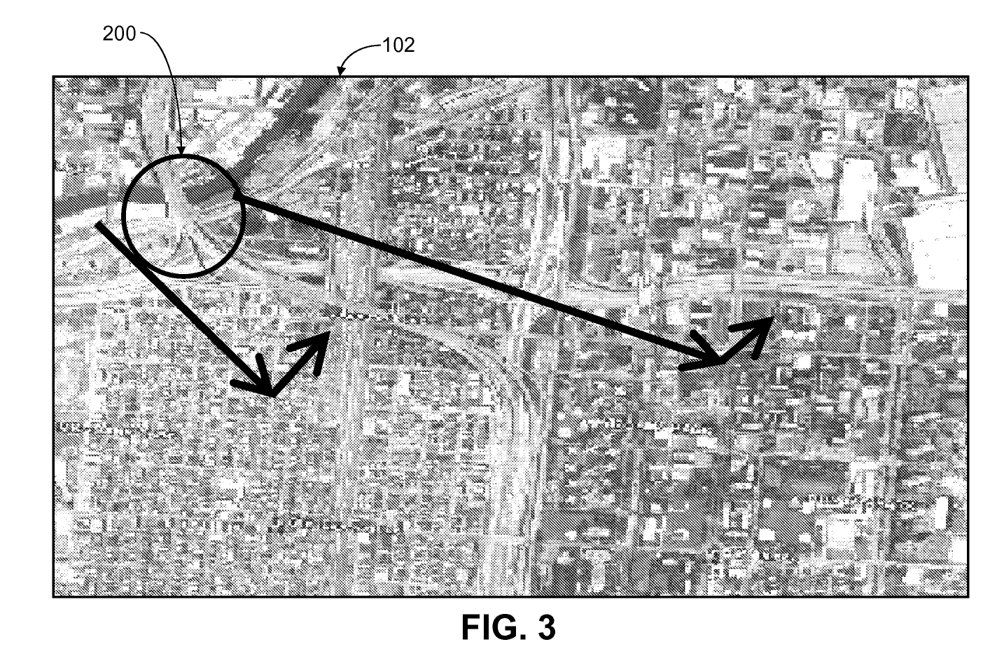

Next consider the same task where the display screen 102 supports multiple touches. This is illustrated in FIG. 3. Here the user makes two simultaneous motions. One motion drags the map to re-center it, while the other motion adjusts both the zoom and the rotation. (Because a motion occurs in two dimensions on the display screen 102, the vertical aspect of the motion can be interpreted to control the zoom while the horizontal aspect controls the rotation. Other implementations may interpret the multiple touches differently.) As seen in FIG. 6, by interpreting simultaneous touches, a multi-touch screen allows the user to make the navigation from the initial view in FIG. 2a to the desired view of FIG. 2b in a single, multiple touch, action.

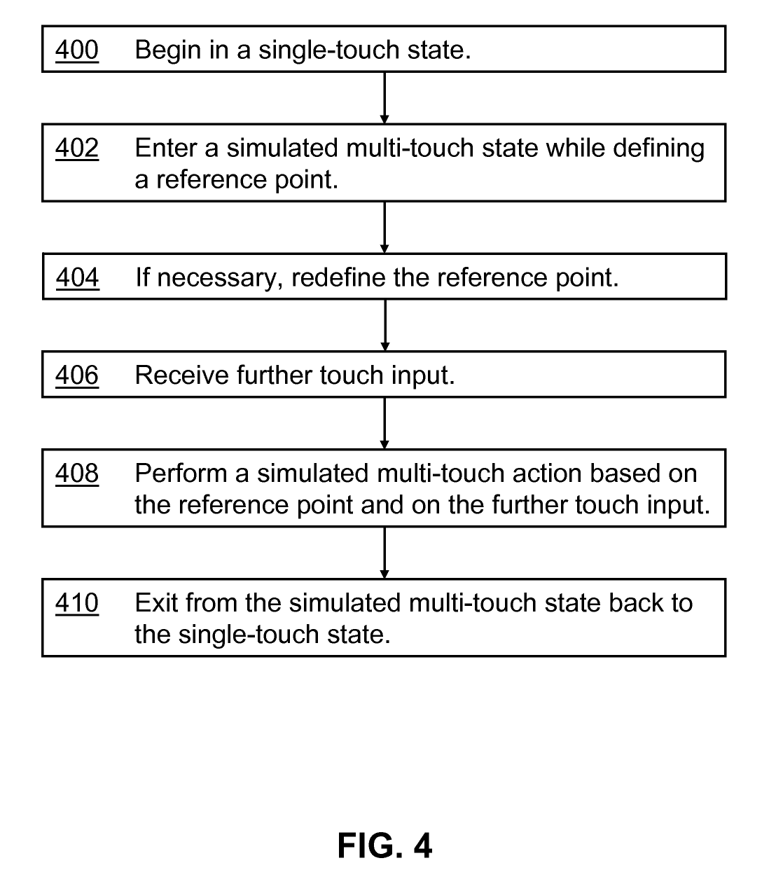

With the advantages of the multi-touch screen fully in mind, we now turn to aspects of the present invention that simulate a multi-touch interface on a less expensive single-touch screen. Note that it is contemplated that different applications may support different simulated multi-touch interfaces. FIG. 4 presents one particular embodiment of the present invention, but it is not intended to limit the scope of the following claims. The user interface begins in the traditional single-touch state (step 400). When the user clicks (or double clicks) on the single-touch display screen 102, the location of the click is compared against the locations of any widgets currently on the screen 102. If the click location matches that of a widget, then the widget's action is performed, and the interface remains in the single-touch state.

Otherwise, the click is interpreted as a request to enter the simulated multi-touch state (step 402). The location of the click is stored as a “reference point.” In some embodiments, a timer is started. If the user does not complete a simulated multi-touch action before the timer expires, then the interface returns to the single-touch state.

In some embodiments, the user can redefine the reference point while in the simulated multi-touch state (step 404). The user clicks or double clicks anywhere on the screen 102 except for on a widget. The click location is taken as the new reference point. (If the user clicks on a widget while in the simulated multi-touch state, the widget's action is performed, and the interface returns to the single-touch state. Thus, a widget can be set up specifically to allow the user to cleanly exit to the single-touch state.) In other embodiments, the user must exit to the single-touch state and re-enter the simulated multi-touch state in order to choose a new reference point.

In any case, while in the simulated multi-touch state, the user can make further touch input (step 406), such as a continuous drawing movement.

The reference point and this further touch input are interpreted as a command to perform a simulated multi-touch action (step 408). If, for example, the user is performing a zoom, the reference point can be taken as the operation center of the zoom while the further touch input can define the level of the zoom. For a second example, the reference point can define the center of a rotation action, while the further touch input defines the amount and direction of the rotation. In other embodiments, the center of an action can be defined not by the reference point alone but by a combination of, for example, the reference point and the initial location of the further touch input. Multiple actions, such as a zoom and a rotation, can be performed together because the further touch input can move through two dimensions simultaneously. In this manner, the simulated multi-touch action can closely mimic the multi-touch interface illustrated in FIG. 3.

When the simulated multi-touch action is complete (signaled, for example, by the end of the further touch input, that is, by the user raising his finger from the single-touch screen 102), the user interface returns to the single-touch state (step 410).

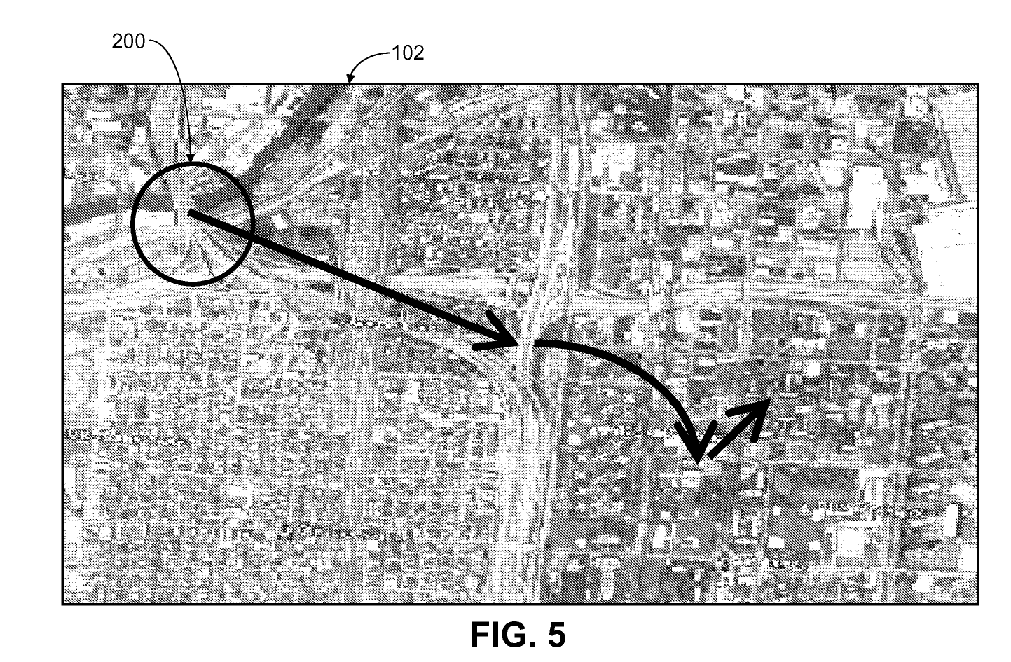

The example of FIG. 5 ties this all together. Again, the user wishes to move from the initial map view of FIG. 2a to the desired view of FIG. 2b. In FIG. 5, the single-touch display screen 102 supports a simulated multi-touch interface. The user enters the simulated multi-touch state by clicking (or double clicking) on the center of the circular area 200. The click also defines the center of the circular area 200 as the reference point. (Note that there are no widgets defined on the screen 102 in FIG. 5, so the user's clicking is clearly meant as a request to enter the simulated multi-touch state.) The user's further touch input consists of a continuous drawing action that re-centers the view (illustrated by the long, straight arrow in FIG. 5). In a second simulated multi-touch action, the user clicks in the center of the view to generate a new reference point and then draws to adjust both the zoom and the rotation (medium length curved arrow in the middle of FIG. 5). Finally, the user adjusts the centering in a single-touch drag action (short straight arrow to the right of FIG. 5).

Turning back to the table of FIG. 6, the simulated multi-touch interface of FIG. 5 requires only three short actions, clearly much better than the traditional single-touch interface. The combination of the defined reference point and the further touch input gives the simulated multi-touch interface enough information to simulate a multi-touch interface even while only recognizing one touch point at a time. Because the further touch input takes place in two dimensions, two operations can be performed simultaneously. Also, the user can carefully adjust these two operations by moving back and forth in each of the two dimensions.

The above examples are appropriate to a map application. Other applications may define the actions performed in the simulated multi-touch interface differently.

In view of the many possible embodiments to which the principles of the present invention may be applied, it should be recognized that the embodiments described herein with respect to the drawing figures are meant to be illustrative only and should not be taken as limiting the scope of the invention. For example, the specific interpretation of touches can vary with the application being accessed. Therefore, the invention as described herein contemplates all such embodiments as may come within the scope of the following claims and equivalents thereof.

We claim:

1. A method for interacting with a single-touch screen, the method comprising:
beginning in a single-touch state;
entering a simulated multi-touch state, wherein entering the simulated multi-touch state is triggered by receiving touch input from the single-touch screen, the triggering touch input defining a reference point on the single-touch screen;
while in the simulated multi-touch state, receiving further touch input from the single-touch screen;
performing a simulated multi-touch action based, at least in part, on the reference point and on the further touch input; and
exiting from the simulated multi-touch state to the single-touch state.

2. The method of claim 1 wherein entering the simulated multi-touch state is triggered by receiving touch input selected from the group consisting of: a single click and a double click, and wherein the reference point is defined as a location on the touch screen of the triggering touch input.

3. The method of claim 1 wherein the reference point does not correspond to an actionable icon on the touch screen.

4. The method of claim 1 wherein the further touch input comprises a continuous drawing movement.

5. The method of claim 1 wherein the simulated multi-touch action is selected from the group consisting of: a zoom action, a rotation action, and a combined zoom/rotation action.

6. The method of claim 5 wherein the simulated multi-touch action is a zoom action, wherein the reference point defines an operation center of the zoom action, and wherein the further touch input defines the zoom.

7. The method of claim 5 wherein the simulated multi-touch action is a zoom action, wherein an operation center of the zoom action is defined, at least in part, by the reference point and by an initial point of the further touch input, and wherein the further touch input defines the zoom.

8. The method of claim 5 wherein the simulated multi-touch action is a rotation action, wherein the reference point defines a center of the rotation, and wherein the further touch input defines the rotation.

9. The method of claim 5 wherein the simulated multi-touch action is a rotation action, wherein a center of the rotation is defined, at least in part, by the reference point and by an initial point of the further touch input, and wherein the further touch input defines the rotation.

10. The method of claim 1 further comprising:
setting a timer upon entering the simulated multi-touch state; and
exiting from the simulated multi-touch state to the single-touch state upon expiration of the timer.

11. The method of claim 1 further comprising:
while in the simulated multi-touch state, receiving further triggering touch input from the single-touch screen; and
if a location on the touch screen of the further triggering touch input corresponds to an actionable icon on the touch screen, then exiting from the simulated multi-touch state to the single-touch state and performing an action associated with the actionable icon.

12. The method of claim 11 wherein the further triggering touch input is selected from the group consisting of: a single click and a double click.

13. The method of claim 11 further comprising:
if a location on the touch screen of the further triggering touch input does not correspond to an actionable icon on the touch screen, then remaining in the simulated multi-touch state and redefining the reference point based, at least in part, on a location on the touch screen of the further triggering touch input.

14. A personal communication device comprising:
a single-touch display screen; and
a processor operatively connected to the single-touch display screen and configured for beginning in a single-touch state, for entering a simulated multi-touch state, wherein entering the simulated multi-touch state is triggered by receiving touch input from the single-touch screen, the triggering touch input defining a reference point on the single-touch screen, for, while in the simulated multi-touch state, receiving further touch input from the single-touch screen, for performing a simulated multi-touch action based, at least in part, on the reference point and on the further touch input, and for exiting from the simulated multi-touch state to the single-touch state.

15. The personal communication device of claim 14 wherein the device is selected from the group consisting of: a cellular telephone, a personal digital assistant, and a personal computer.

16. The personal communication device of claim 14 wherein entering the simulated multi-touch state is triggered by receiving touch input selected from the group consisting of: a single click and a double click, and wherein the reference point is defined as a location on the touch screen of the triggering touch input.

17. The personal communication device of claim 14 wherein the reference point does not correspond to an actionable icon on the touch screen.

18. The personal communication device of claim 14 wherein the further touch input comprises a continuous drawing movement.

19. The personal communication device of claim 14 wherein the simulated multi-touch action is selected from the group consisting of: a zoom action, a rotation action, and a combined zoom/rotation action.

20. The personal communication device of claim 19 wherein the simulated multi-touch action is a zoom action, wherein the reference point defines an operation center of the zoom action, and wherein the further touch input defines the zoom.

21. The personal communication device of claim 19 wherein the simulated multi-touch action is a zoom action, wherein an operation center of the zoom action is defined, at least in part, by the reference point and by an initial point of the further touch input, and wherein the further touch input defines the zoom.

22. The personal communication device of claim 19 wherein the simulated multi-touch action is a rotation action, wherein the reference point defines a center of the rotation, and wherein the further touch input defines the rotation.

23. The personal communication device of claim 19 wherein the simulated multi-touch action is a rotation action, wherein a center of the rotation is defined, at least in part, by the reference point and by an initial point of the further touch input, and wherein the further touch input defines the rotation.

24. The personal communication device of claim 14 wherein the processor is further configured for setting a timer upon entering the simulated multi-touch state and for exiting from the simulated multi-touch state to the single-touch state upon expiration of the timer.

25. The personal communication device of claim 14 wherein the processor is further configured for, while in the simulated multi-touch state, receiving further triggering touch input from the single-touch screen and for, if a location on the touch screen of the further triggering touch input corresponds to an actionable icon on the touch screen, then exiting from the simulated multi-touch state to the single-touch state and performing an action associated with the actionable icon.

26. The personal communication device of claim 25 wherein the further triggering touch input is selected from the group consisting of: a single click and a double click.

27. The personal communication device of claim 25 wherein the processor is further configured for, if a location on the touch screen of the further triggering touch input does not correspond to an actionable icon on the touch screen, then remaining in the simulated multi-touch state and redefining the reference point based, at least in part, on a location on the touch screen of the further triggering touch input.
